(19) United States
(12) Patent Application Publication
(10) Pub. No.: US 2014/0076174 A1
(43) Pub. Date: Mar. 20, 2014

(54) Slow Cooking Appliance with Lid Latching Arrangement

(71) Applicant: Sunbeam Products, Inc., Boca Raton, FL (US)

(72) Inventors: Steve Vernaglia, Boca Raton, FL (US); Enrique Plazarte, Fort Lauderdale, FL (US); Larry Randall, Coral Springs, FL (US)

(73) Assignee: Sunbeam Products, Inc., Boca Raton, FL (US)

(21) Appl. No.: 14/032,398

(22) Filed: Sep. 20, 2013

Related U.S. Application Data
(60) Provisional application No. 61/703,462, filed on Sep. 20, 2012.

(51) Int. Cl. A47J 27/00

(52) U.S. Cl. CPC A47J 27/004
USPC 99/324

(57) ABSTRACT

A slow cooker including a housing, cooking vessel with a rim and a lid. At least one latching arrangement is disposed on the lid and a complementary engagement member disposed on a sidewall of the housing configured to selectively retain the lid in sealing engagement with the cooking vessel rim and the housing to inhibit leakage of the food stuffs from the interior of the cooking vessel. The at least one latching arrangement includes a base attached to the lid and an elastic tie down connected to the base having an elongated portion with a stop member formed thereon configured to engage the engagement member. The stop member engages the engagement member by extending the elastic tie down such that the stop member is moved past the engagement member and when the elastic tie down is released the stop member is restrained by the engagement member.

### CROSS-REFERENCE TO RELATED APPLICATION

This application claims priority to U.S. Provisional Patent Application No. 61/703,462 filed on Sep. 20, 2012, which is incorporated herein by reference as if fully rewritten herein.

### FIELD OF THE INVENTION

The present invention relates to a slow cooker and, in particular, to a slow cooker with at least one lid latch to secure the lid to the cooking vessel and housing so the slow cooker can be easily transported with little to no spillage of contents therein.

### BACKGROUND OF THE INVENTION

Slow cooker appliances have been broadly used in households since at least the 1970's and are commonly used for a variety of purposes. Slow cookers are convenient ways to cook a wide variety of foods including, but not limited to, soups, stews, dips, chilis, roasts, and other large cuts of meat at a lower temperature for extended periods of time. One benefit of slow cookers is that a user may add all the ingredients for a meal, namely, the meat, starches, vegetables, and so forth, together into one appliance and it will “slow cook” during the day and be ready for consumption at dinner time.

Typically, slow cookers include a ceramic or stoneware cooking vessel received in a metal housing. A transparent glass or plastic lid may be removably mounted on the cooking vessel. The housing may include electronic controls and heating element(s) for heating food stuffs placed within the cooking vessel. The housing generally has handles extending therefrom to allow a user to relatively easily grasp and move the slow cooker. Often, the user may want to move the slow cooker after it is loaded with the food stuffs to be cooked.

One drawback commonly associated with slow cookers is that the lids are not securely engaged to the cooking vessel and the housing. As such, the lid may slide off the cooking vessel when the slow cooker is being transported allowing foodstuffs to spill from the cooking vessel. Accordingly, there is a need to secure the lid to cooking vessel and housing to prevent spillage during transport.

### SUMMARY OF THE INVENTION

In an embodiment, there is provided a cooking appliance including a housing, a cooking vessel having a rim, the cooking vessel being configured to be removably nestable within the housing, a lid configured to removably cover the cooking vessel when seated on the rim, a heating element powered by a power source for heating a food product positioned within an interior of the cooking vessel, at least one latch disposed on the lid and a complementary engagement member disposed on a sidewall of the housing configured to selectively retain the lid in sealing engagement with the cooking vessel rim and the housing to inhibit leakage of the food stuffs from the interior of the cooking vessel. The at least one latch includes a base attached to the lid and an elastic tie down having an elongated portion connected to the base with a stop member formed thereon, the stop member configured to engage the engagement member by extending the elastic tie down such that the stop member is moved past the engagement member and when the elastic tie down is released the stop member is restrained by the engagement member.

In an embodiment, there is provided a slow cooker including a housing, a cooking vessel having a rim, the cooking vessel being configured to be removably nestable within the housing, a lid configured to removably cover the cooking vessel when seated on the rim, a heating element powered by a power source for heating a food product positioned within an interior of the cooking vessel, at least two opposing latches disposed on the lid and complementary engagement members disposed on a sidewall of the housing configured to selectively retain the lid in sealing engagement with the cooking vessel rim and the housing to inhibit leakage of the food stuffs from the interior of said cooking vessel. Each of the latches includes a base attached to the lid and an elastic tie down connected to the base with a stop member formed thereon, the stop member configured to engage the complementary engagement member by extending the elastic tie down such that the stop member is moved past the engagement member and when the elastic tie down is released the stop member is restrained by the engagement member.

In an embodiment, there is provided a slow cooker including a housing, a cooking vessel having a rim, the cooking vessel being configured to be removably nestable within the housing, a lid configured to removably cover the cooking vessel when seated on the rim, a heating element powered by a power source for heating a food product positioned within an interior of the cooking vessel, and a pair of opposing latches disposed on one of the lid or a sidewall of the housing and complementary engagement members disposed on the other of the lid or sidewall of the housing configured to selectively retain the lid in sealing engagement with the cooking vessel rim and the housing to inhibit leakage of the food stuffs from the interior of the cooking vessel. The latches each include a base and an elastic tie down connected to the base with a stop member fowled thereon, the stop member configured to engage the engagement member by extending the elastic tie down such that the stop member is moved past the engagement member and when the elastic tie down is released the stop member is restrained by the engagement member.

In an embodiment, there is provided a slow cooker including a housing, a cooking vessel having a rim, the cooking vessel being configured to be removably nestable within the housing, a lid configured to removably cover the cooking vessel when seated on the rim, a heating element powered by a power source for heating a food product positioned within an interior of the cooking vessel, a pair of opposing latches disposed on the lid and complementary engagement members disposed on the sidewall of the housing configured to selectively retain the lid in sealing engagement with the cooking vessel rim and the housing to inhibit leakage of the food stuffs from the interior of the cooking vessel. The latches each include a base attached to the lid and an elastic tie down connected to the base, the elastic tie down having an aperture formed therein configured to engage the engagement member by extending the elastic tie down such that the aperture is moved into alignment with the engagement member and when the elastic tie down is released the aperture is restrained by the engagement member.

In an embodiment, there is provided a slow cooker including a housing, a cooking vessel having an inner and outer surface and a rim, the cooking vessel being configured to be removably nestable within the housing, a lid configured to removably cover the cooking vessel when seated on the rim, a heating element powered by a power source for heating a food product positioned within an interior of the cooking vessel, a pair of opposing latches disposed on one of the lid or a sidewall of the housing and complementary engagement members disposed on the other of the lid or sidewall of the housing configured to selectively retain the lid in sealing engagement with the cooking vessel rim and the housing to inhibit leakage of the food stuffs from the interior of the cooking vessel. Each latch includes a base attached to the lid or the sidewall of the housing and an elastic tie down connected to the base with an aperture formed therein, the aperture configured to engage the engagement member by extending the elastic tie down such that the aperture is moved in alignment with the engagement member and when the elastic tie down is released the aperture is restrained by the engagement member.

In an embodiment, there is provided a slow cooker including a housing, a cooking vessel having an inner and outer surface and a rim, the cooking vessel being configured to be removably nestable within the housing, a lid configured to removably cover the cooking vessel when seated on the rim, wherein the lid further includes a gasket around an outer edge thereof for sealing engagement with the cooking vessel rim, a heating element powered by a power source for heating a food product positioned within an interior of the cooking vessel, at least one latch disposed on the lid and an engagement member disposed on a sidewall of the housing configured to selectively retain the lid in sealing engagement with the cooking vessel rim and the housing to inhibit leakage of the food stuffs from the interior of the cooking vessel. The at least one latch includes a base attached to the lid and an elastic tie down connected to the base with a stop member formed thereon, the stop member configured to engage the engagement member by extending the elastic tie down such that the stop member is moved past the engagement member and when the elastic tie down is released the stop member is restrained by the engagement member.

Other aspects and advantages of the present invention will be apparent from the following detailed description of the several embodiments and the accompanying drawings.

### BRIEF DESCRIPTION OF THE DRAWINGS

The accompanying drawings form a part of the specification and are to be read in conjunction therewith, in which like reference numerals are employed to indicate like or similar parts in the various views.

FIG. 1 is a perspective view of one embodiment of the present slow cooker constructed in accordance with the teachings of the present invention;

FIG. 2 is an exploded view of the slow cooker shown in FIG. 1;

FIG. 3 is a cross-sectional view of the slow cooker shown in FIG. 1;

FIG. 4 is a partial cutaway perspective view of the slow cooker shown in FIG. 1;

FIG. 5 is a partial cutaway perspective view of another embodiment of a slow cooker similar to the one shown in FIG. 1 but with an alternate lid latch and tie down arrangement;

FIG. 6 is a perspective view of another embodiment of a slow cooker similar to the one shown in FIG. 1 but with a carrying handle;

FIG. 7 is a perspective view of another embodiment of a slow cooker similar to the one shown in FIG. 1 with an alternate lid latch and tie down arrangement;

FIG. 8 is an exploded perspective view of the slow cooker shown in FIG. 7; and

FIG. 9 is a perspective view of another embodiment of a slow cooker similar to the one shown in FIG. 7 but with a carrying handle.

### DETAILED DESCRIPTION OF THE INVENTION

The following detailed description of the present invention references the accompanying drawing figures that illustrate specific embodiments in which the invention can be practiced. The embodiments are intended to describe aspects of the present invention in sufficient detail to enable those skilled in the art to practice the invention. Other embodiments can be utilized and changes can be made without departing from the spirit and scope of the present invention. The present invention is defined by the appended claims and, therefore, the description is not to be taken in a limiting sense and shall not limit the scope of equivalents to which such claims are entitled.

Slow cooker appliances such as that disclosed herein include, but are not limited to, the slow cookers disclosed in U.S. Pat. Nos. 6,740,855, 6,587,739 and 7,312,425, all of which are incorporated herein by reference. The slow cooker of the present invention includes at least one but preferably two opposing elastic latches connected to the lid for securing the lid to the slow cooker cooking vessel and housing during transport to prevent spillage.

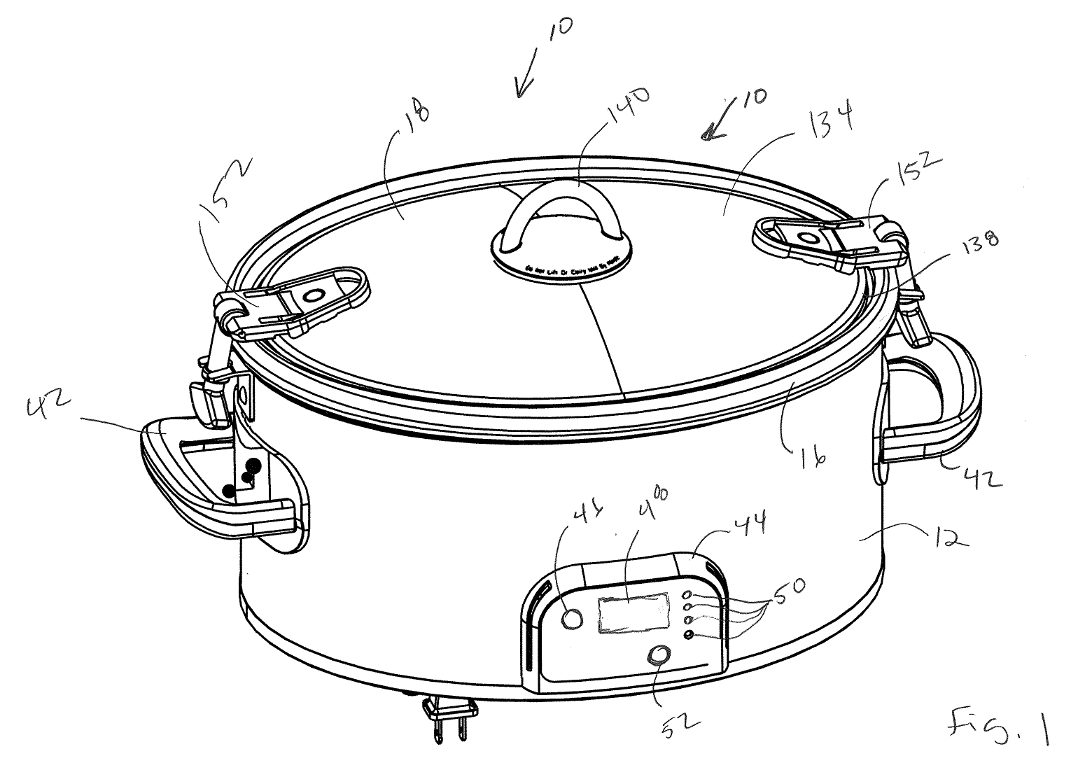

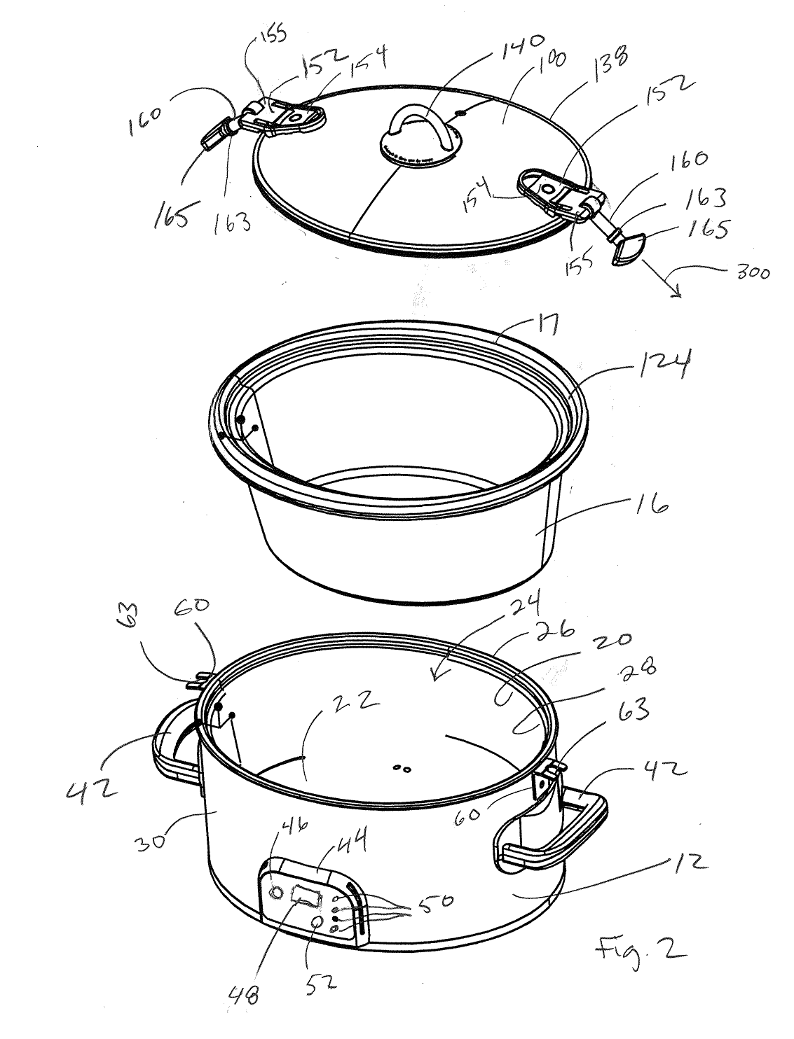

Referring to FIGS. 1-3, there is illustrated a slow cooker 10 including, but not limited to, a housing 12, a cooking vessel 16 seated within the housing 12, and a lid 18 configured to removably seat on and cover cooking vessel 16. As best shown in FIG. 2, housing 12 includes a sidewall 20, a bottom wall 22, and an open top 24 defined by a top annular rim 26. Sidewall 20 includes an inner wall 28 and an outer wall 30 defining a sidewall thickness therebetween. Bottom wall 22 includes a bottom inner wall 32 and a bottom outer wall 34 also defining a bottom thickness therebetween. Housing 12 further includes at least one heating element 38 positioned and located between inner walls 28 and 32 and outer walls 30 and 34 as shown.

Inner walls 28 and 32 may be comprised of a wide variety of materials including aluminum, stainless steel, copper, or any other known commercial alloy or other suitable material. Metal inner walls 28 and 32 are beneficial in transferring heat from housing 12 to the cooking vessel 16. Outer walls 30 and 34 may also be comprised of aluminum, stainless steel, copper, or any other known commercial alloy, glass, carbon fiber, composite, ceramic, or some temperature resistant plastics depending upon the amount of heat that is transferred to outer walls 30 and 34. The selection of the material of outer walls 30 and 34 may be made for both functional and aesthetic reasons. Other similar and functionally equivalent materials now known or hereafter developed may be used for both inner walls 28 and 32, and outer walls 30 and 34. Outer wall 30 of sidewall 20 may also include opposing handles 42 coupled thereto as shown in FIGS. 1 and 2.

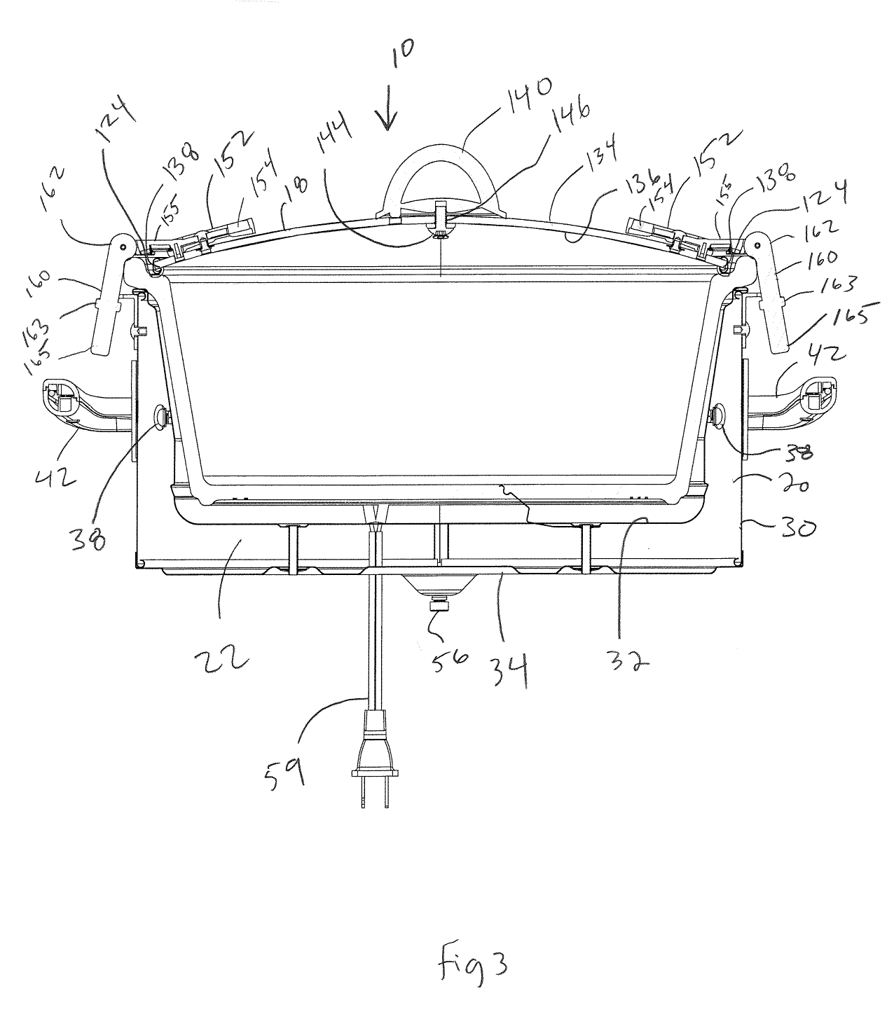

In an embodiment, a control panel 44 may be coupled to outer wall 30 as shown. In the illustrated embodiment, control panel 44 includes a plurality of electronic controls including, but not limited to, one or more of the following: an on/off switch 46, a timer 48, a cooking mode indicator 50, and a cooking mode switch 52. Slow cooker 10 is generally a standard plug-in type electrical cooking device which includes a power cord 59 as best illustrated in FIG. 3. It is however also recognized and anticipated that slow cooker 10 could be configured to be alternatively powered by some other power source. On/Off switch 46 turns slow cooker 10 on and off. Timer 48 may display the current time, the remaining cooking time, the actual cooking time, and/or other timer or clock features now known or hereafter developed. Cooking mode indicator 50 displays which cooking mode or temperature range has been selected by a user through cooking mode switch 52. Common examples are: low, medium, high, or warm. One embodiment includes indicators which are designated as “HI,” “LO,” and “WM.” Alternatively, cooking mode indicator 50 may display an actual cooking temperature and/or time duration to be selected by the user. Cooking mode indicator 50 may also include an indication of cooking time ranges associated with each cooking temperature range. For example, control panel 44 may include a cooking mode indicator 50 that displays several operating times for each of the HI and LO settings such as preset times of 4 hours and 6 hours for the HI setting, and 8 hours and 10 hours for the LO setting. In one embodiment, slow cooker 10 may operate at a high temperature for about four (4) hours and then switch to a warming mode. One embodiment may also include a warming mode that is either (1) activated after the completion of the selected cooking mode and time duration, or (2) a separate setting chosen by the user. Still further, mode indicator 50 may be an LED or other light positioned next to the written description of the cooking mode, time or temperature. It is recognized and anticipated that still other settings may be used and any configuration of preset times and cooking temperatures may be incorporated into control panel 44 and slow cooker 10 and all such variations are intended to be within the scope of the present invention.

In an embodiment, housing 12 may also include a plurality of legs 56 extending away from bottom wall 22 for supporting the slow cooker 10 on a surface. Legs 56 may be integrally formed with bottom wall 22 or they may be coupled thereto using any known coupling or fastener means.

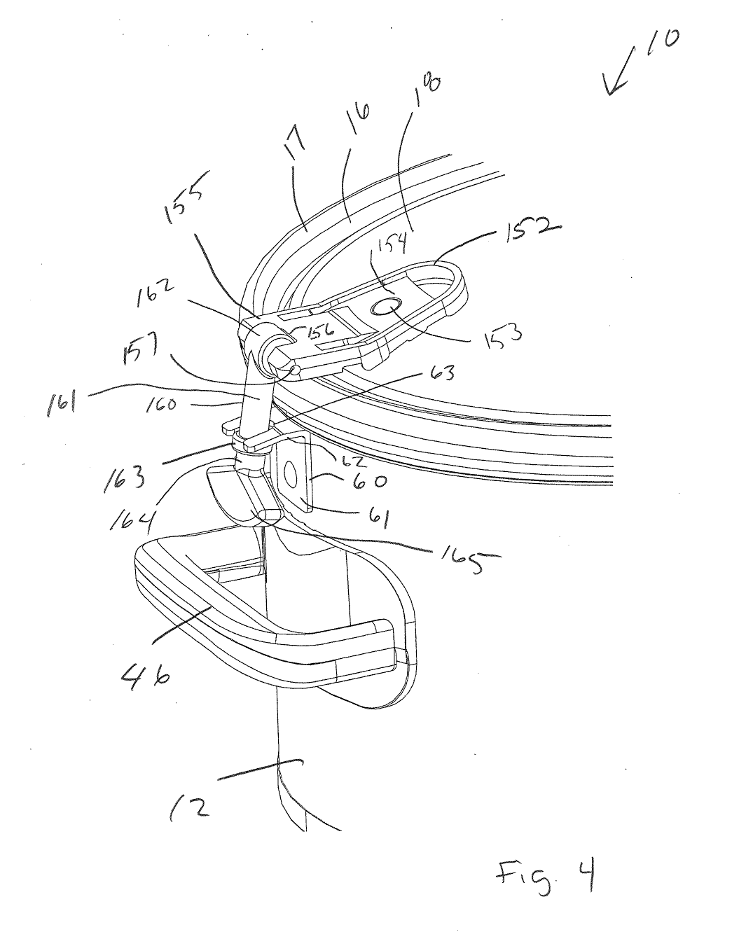

Referring now also to FIG. 4, in an embodiment housing 12 may include u-shaped brackets 60 or other engagement members 60 that are configured to engage one or more latching arrangements 152 associated with lid 18 for securing lid 18 to housing 12 as will be further described below. As further illustrated in FIG. 3, lid 18 includes an outer surface 134, an inner surface 136, an annular rim 138, and a handle 140. Annular rim 138 of lid 18 is configured to rest upon ledge 124 as shown. When annular rim 138 rests upon ledge 124, cooking vessel 16 is substantially enclosed thereby capturing heat and moisture which assist the cooking process. Handle 140 may be coupled to or otherwise attached to outer surface 134 of lid 18 through the use of a fastener 144 which passes through an aperture 146 extending through both inner surface 134 and outer surface 136 of lid 18 and which is received into handle 140 as shown. Another embodiment (not shown) may include a lid 18 having handle 140 integrally formed therewith.

Lid 18 may further include at least one latching arrangement 152 and preferably two latching arrangements 152 as shown in FIGS. 1-3 at opposing sides of lid 18 proximate annular rim 138. As best seen in FIG. 4, each latching arrangement 152 may include a base 154 secured to lid 18 with a fastener 153 which may be any type of fastener such as a rivet, screw, adhesive, etc., as is known to one of ordinary skill. Base 154 may include an angled cantilever portion 155 extending over rim 17 of cooking vessel 16. Base 154 may also include a cutout portion 156 formed in cantilever portion 155 for pivotally receiving a first end 162 of an elastic tie down 160 preferably formed from a food grade elastomer including but not limited to rubber or silicone. First end 162 may be pivotally secured to the cantilever portion 155 via a pin 157 inserted into an aperture formed in cantilever portion 155 on opposing sides of cutout portion 156. An axial bore (not shown) in first end 162 of tie down 160 receives pin 157 for pivotally securing it to cantilever portion 155. An elongated cylindrical portion 161 of tie down 160 is connected to first end 162.

A grip 165 is connected to an opposite end or second end 164 of cylindrical portion 161 of elastic tie down 160. A stop 163 comprised of an annular ridge 163 is formed on cylindrical portion 161 of elastic tie down 160 proximate grip 165. Annular ridge 163 of tie down 160 engages a cutout portion 63 of u-shaped bracket 60 on one side of housing 12 when stretched or pulled in a generally axial direction (represented by arrow 300 in FIG. 2) to secure one side of lid 18 to housing 12. Cutout portion 63 of u-shaped bracket 60 is formed in a horizontally extending portion 62 connected in cantilever fashion to a vertically extending portion 61. Vertically extending portion 61 of u-shaped bracket 60 is attached to the sidewall of housing 12 by a fastener such as rivet or other means such as welding as is known to one of ordinary skill in the art.

Grip 165 is wedge-shaped so that it may be grasped and pulled with equal force on opposite portions of grip 165 so that a combined axial force may be placed onto cylindrical portion 161 of elastic tie down 160 to cause annular ridge 163 to be pulled or extended past u-shaped bracket 60 to seat or unseat annular ridge 163 on u-shaped bracket 60 beneath cutout 63. After annular ridge 163 is pulled past u-shaped bracket 60 cylindrical portion 161 is moved into cutout 63 and annular ridge 163 moved underneath cutout 63. Cutout 63 allows cylindrical portion 161 to pass through u-shaped bracket 60 but catches annular ridge 163 underneath it since annular ridge 163 is larger in size than cutout 63. When grip 165 is released, annular ridge 163 is seated beneath u-shaped bracket 60 beneath cutout 63 and cylindrical portion 161 is put under tension to cause a downward force to be placed onto each base 154 of each latching arrangement 152. This causes annular rim 138 of lid 18 to be urged against ledge 124 securing lid 18 to cooking vessel 16 and housing 12. When it is desired to remove lid 18 from cooking vessel 16 and housing 12, grip 165 is again pulled on each elastic tie down 160 generally in axial direction 300 until annular ridge 163 is unseated from u-shaped bracket 60 and moved away from it such that annular ridge 163 is no longer caught underneath cutout 63.

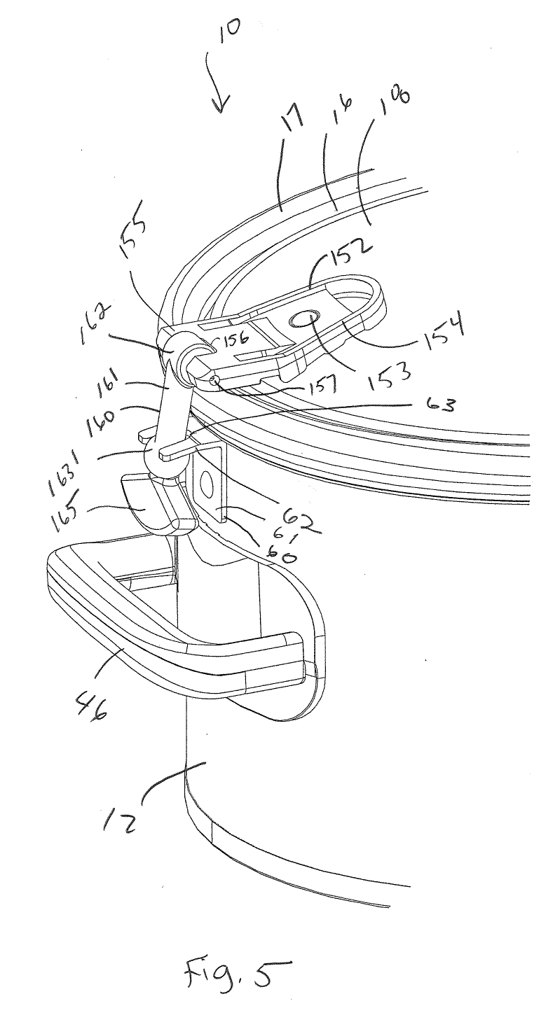

Referring now also to FIG. 5, there is illustrated a partially cutaway view of an alternate embodiment of a slow cooker 10 similar to the foregoing embodiment with alternate latch arrangements 152 arranged on opposite sides of lid 18 (one shown) for securing lid 18 to cooking vessel 16 and housing 12. Latch arrangement 152 is identical in all respects but annular ridge 163 on cylindrical portion 161 of elastic tie down 160 in FIGS. 1-4 has been replaced with a spherical stop member 163′ which seats against the lower surface of horizontally extending portion 62 of u-shaped bracket 60. The lower surface of horizontally extending portion 62 of u-shaped bracket 60 may be any shape including flat or concave and of identical radius as spherical stop member 163′ to ensure a snug fit of spherical stop member 163′ against the lower surface of u-shaped bracket 60 when seated.

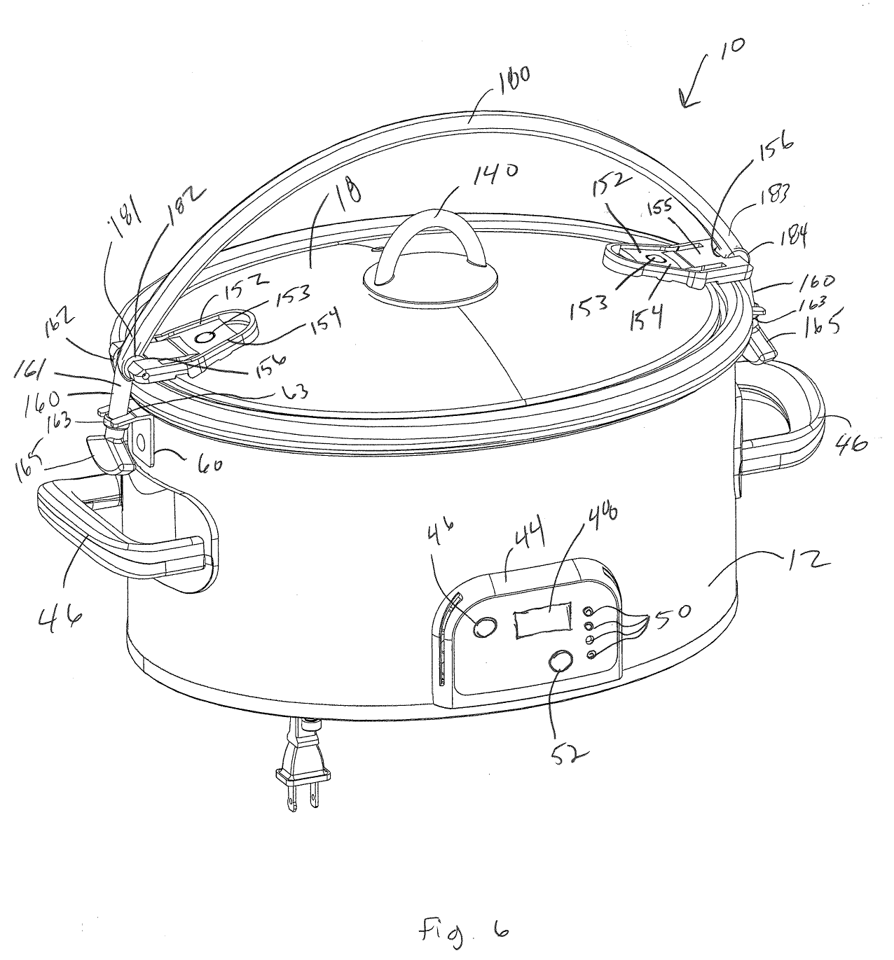

Referring now also to FIG. 6, there is illustrated an embodiment of a slow cooker 10 similar to the foregoing embodiments illustrated in FIGS. 1-5 with the addition of an arc-shaped carrying handle 180 to enable the slow cooker 10 to be transported with one hand. The carrying handle 180 has a first end 181 with a hub portion 182 that is co-seated with a first end 162 of an elastic tie down 160 of one of the latching arrangements 152 disposed on one side of the lid 18. The hub portion 182 is co-seated with the first end 162 in cutout portion 156 of cantilever portion 155 of base 154 of latch arrangement 152 such that first end 162 is free to rotate relative to hub portion 182. This freedom of rotation allows elastic tie down 160 to be rotated to seat annular ridge 163 or spherical member 163′ on u-shaped bracket 60 beneath cutout 63 to secure lid 18 to cooking vessel 16 and housing 12. Carrying handle 180 has a second end 183 with a hub portion 184 that is co-seated with a first end 162 of another elastic tie down 160 of another one of the latching arrangements 152 disposed on an opposite side of lid 18. When the annular ridge 163 or spherical member 163′ are seated against respective u-shaped brackets 60 lid 18 is secured to cooking vessel 16 and housing 12.

In another embodiment, the u-shaped bracket 60 and base 154 connected to tie down 160 of the latching arrangements 152 of the foregoing embodiments may be reversed such that base 154 connected to tie down 160 is attached to the sidewall of the housing 12 and engagement member 60 including the u-shaped bracket 60 may be attached to the lid 18 to secure the lid to the cooking vessel 16 and housing 12.

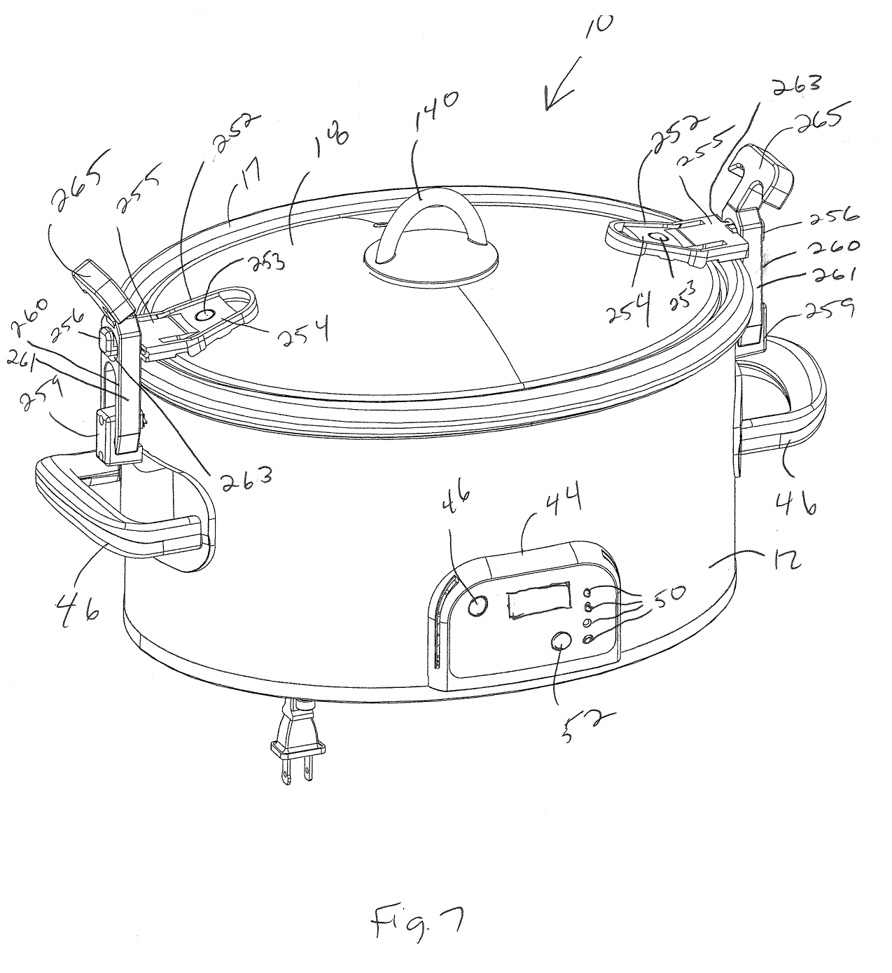

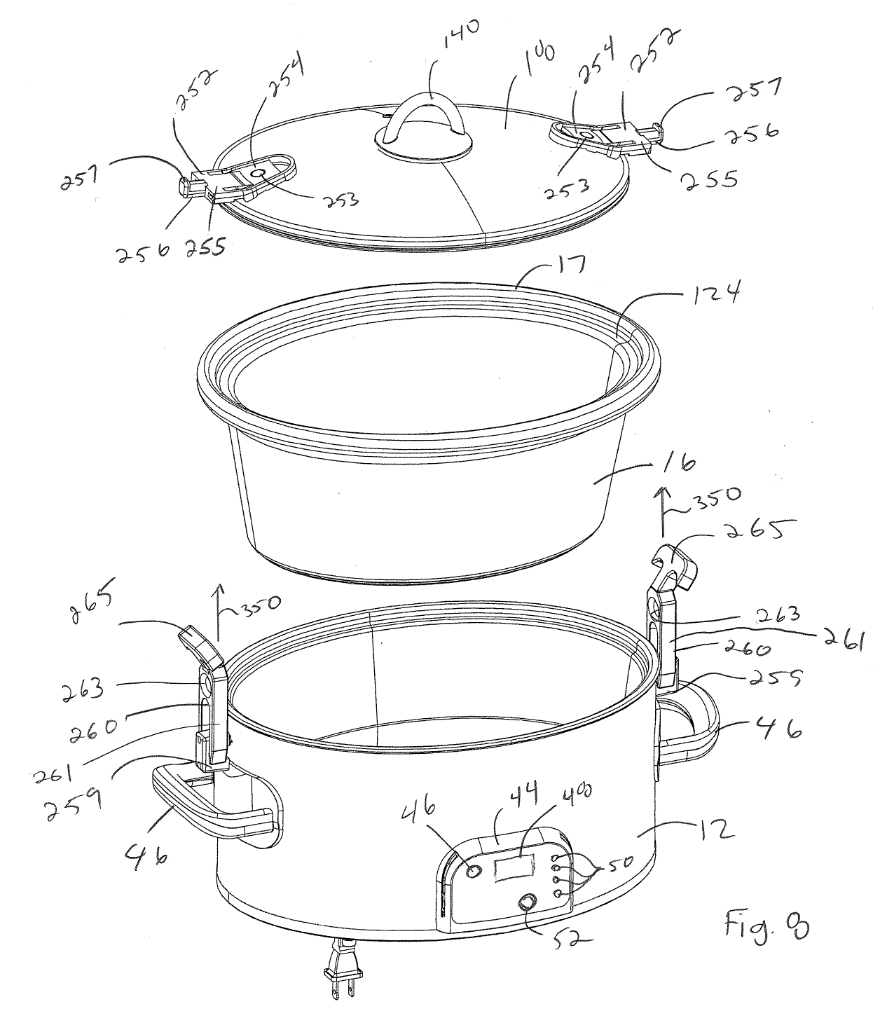

Referring now also to FIGS. 7-9, there is illustrated an embodiment of a slow cooker appliance 10 similar to the previous embodiments but with an alternate latching arrangement 252 disposed on lid 18. Preferably, there are two latching arrangements 252 disposed on opposing sides of lid 18. As best seen in FIG. 8, each latching arrangement 252 may include an attachment portion including an attachment base 254 secured to lid 18 with a fastener 253 which may be any type of fastener such as a rivet, screw, adhesive, etc., as is known to one of ordinary skill. Attachment base 254 may include an angled cantilever portion 255 extending over rim 17 of cooking vessel 16. A projection 256 with a hook 257 at an end extends from cantilever portion 255 for selectively inserting into an aperture 263 formed in an elongated portion 261 of elastic tie down 260. Elastic tie down 260 is preferably formed from a food grade elastomer including but not limited to rubber or silicone. One end of tie down 260 may be connected to a base 259 attached to the sidewall of the housing 12. A tee-shaped grip 265 may be attached to an opposite end of tie down 260 so that when pulled a combined axial force generally in the direction of arrow 350 may be placed onto tie down 260 to cause aperture 263 to be aligned with and seated onto projection 256. When projection 256 is seated into aperture 263, tie down 260 is put under tension to cause a downward force to be placed onto each attachment base 254 of each latching arrangement 252. This causes annular rim 138 of lid 18 to be urged against ledge 124 securing lid 18 to cooking vessel 16 and housing 12.

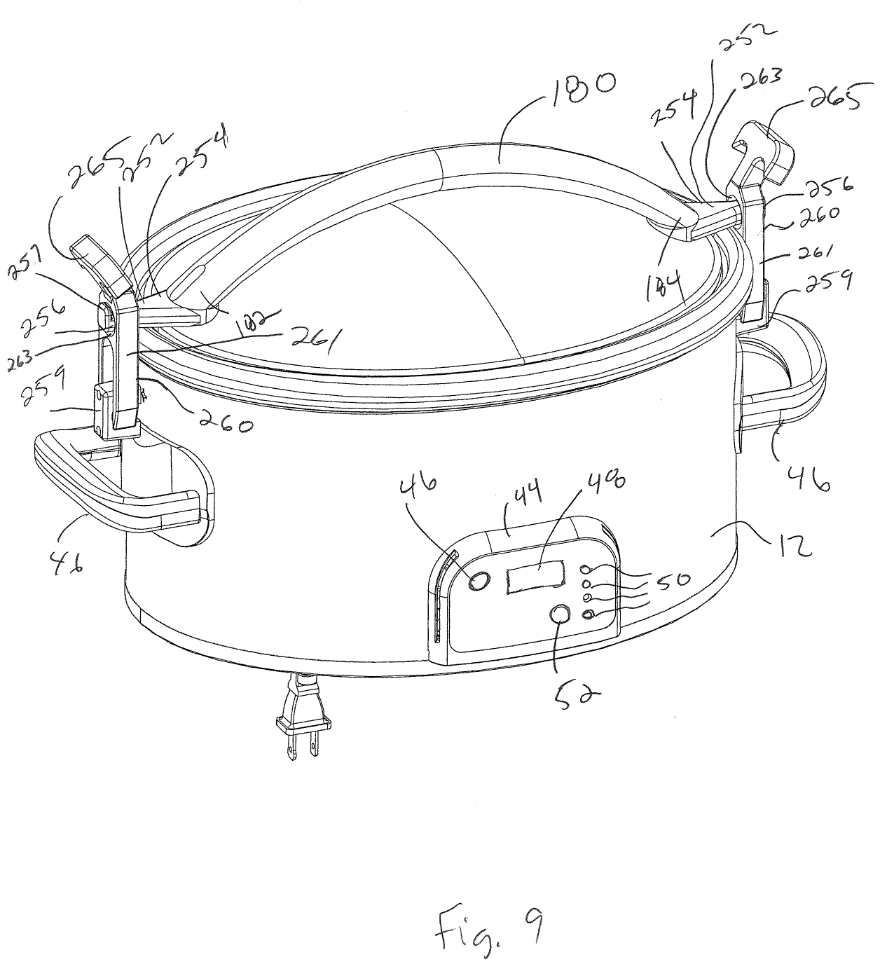

Referring now specifically to FIG. 9, there is illustrated an embodiment of a slow cooker 10 similar to the embodiment illustrated in FIGS. 8-9 with the addition of an arc-shaped carrying handle 180 to enable the slow cooker 10 to be transported with one hand. The carrying handle 180 has a first end 182 connected to attachment base 254 of one of latches 252 and an opposite end 184 connected to attachment base 254 of the other opposing latch 252.

In another embodiment, attachment base 254 and base 259 connected to tie down 260 of the latching arrangements 252 of the foregoing embodiments may be reversed such that base 259 connected to tie down 260 is attached to lid 18 and attachment base 254 connected to projection 256 may be attached to the lid 18 to secure the lid to the cooking vessel 16 and housing 12.

Thus, there has been shown and described several embodiments of a novel slow cooker with a latching arrangement for securing the lid to the cooking vessel and housing. Many changes, modifications, variations and other uses and applications of the present invention will, however, become apparent to those skilled in the art after considering this specification and the accompanying drawings. All such drawings, modifications, variations and other uses and applications which do not depart from the spirit and scope of the present invention are deemed to be covered by the present invention which is limited only by the claims which follow.

What is claimed is:

1. A cooking appliance, comprising:
a housing;
a cooking vessel having a rim, said cooking vessel being configured to be removably nestable within said housing;
a lid configured to removably cover said cooking vessel when seated on said rim;
a heating element powered by a power source for heating a food product positioned within an interior of said cooking vessel;
at least one latch disposed on said lid and a complementary engagement member disposed on a sidewall of said housing configured to selectively retain said lid in sealing engagement with said cooking vessel rim and said housing to inhibit leakage of the food stuffs from said interior of said cooking vessel, said at least one latch including a base attached to said lid and an elastic tie down having an elongated portion connected to said base with a stop member formed thereon, said stop member configured to engage said engagement member by extending said elastic tie down such that said stop member is moved past said engagement member and when said elastic tie down is released said stop member is restrained by said engagement member.

2. The appliance of claim 1, wherein said lid further includes a gasket around an outer edge thereof for sealing engagement with said cooking vessel rim.

3. The appliance of claim 1, wherein said stop member is an annular ridge formed on said elongated portion of said elastic tie down.

4. The appliance of claim 1, wherein said stop member is spherical shaped formed on said elongated portion of said elastic tie down.

5. The appliance of claim 1, wherein said elastic tie down is farmed from an elastomer selected from the group comprised of rubber and silicone.

6. The appliance of claim 1, wherein said engagement member is a u-shaped bracket having a cutout portion and a lower surface beneath the cutout portion that abuts the stop member of said elastic tie down when in a latched configuration.

7. A slow cooker, comprising:
a housing;
a cooking vessel having a rim, said cooking vessel being configured to be removably nestable within said housing;
a lid configured to removably cover said cooking vessel when seated on said rim;
a heating element powered by a power source for heating a food product positioned within an interior of said cooking vessel;
at least two opposing latches disposed on said lid and complementary engagement members disposed on a sidewall of said housing configured to selectively retain said lid in sealing engagement with said cooking vessel rim and said housing to inhibit leakage of the food stuffs from said interior of said cooking vessel, each of said latches including a base attached to said lid and an elastic tie down connected to said base with a stop member formed thereon, said stop member configured to engage said complementary engagement member by extending said elastic tie down such that said stop member is moved past said engagement member and when said elastic tie down is released said stop member is restrained by said engagement member.

8. The slow cooker of claim 7, wherein said lid further includes a gasket around an outer edge thereof for sealing engagement with said vessel rim.

9. The slow cooker of claim 7, wherein said stop member is an annular ridge formed on said elongated portion of said elastic tie down.

10. The slow cooker of claim 7, wherein said stop member is spherical shaped formed on said elongated portion of said elastic tie down.

11. The slow cooker of claim 7, wherein said elastic tie down is formed from an elastomer selected from the group comprised of rubber and silicone.

12. The slow cooker of claim 7, wherein said engagement member is a u-shaped bracket having a cutout portion and a lower surface beneath the cutout portion that abuts the stop member of said elastic tie down when in a latched configuration.

13. The slow cooker of claim 7, further including a carrying handle extending over said lid from said base of one of said latches to said base of said other of said latches.

14. The slow cooker of claim 13, wherein said carrying handle is arc-shaped.

15. A slow cooker, comprising:
a housing;
a cooking vessel having a rim, said cooking vessel being configured to be removably nestable within said housing;
a lid configured to removably cover said cooking vessel when seated on said rim;
a heating element powered by a power source for heating a food product positioned within an interior of said cooking vessel;
a pair of opposing latches disposed on one of said lid or a sidewall of said housing and complementary engagement members disposed on the other of said lid or sidewall of said housing configured to selectively retain said lid in sealing engagement with said cooking vessel rim and said housing to inhibit leakage of the food stuffs from said interior of said cooking vessel, said latches each including a base and an elastic tie down connected to said base with a stop member formed thereon, said stop member configured to engage the engagement member by extending said elastic tie down such that said stop member is moved past said engagement member and when said elastic tie down is released said stop member is restrained by said engagement member.

16. The slow cooker of claim 15, wherein said stop member is an annular ridge formed on said elongated portion of said elastic tie down.

17. The slow cooker of claim 15, wherein said stop member is spherical shaped formed on said elongated portion of said elastic tie down.

18. The slow cooker of claim 15, wherein said elastic tie down is formed from an elastomer selected from the group comprised of rubber and silicone.

19. The slow cooker of claim 15, wherein said engagement member is a u-shaped bracket having a cutout portion and a lower surface beneath the cutout portion that abuts the stop portion of said elastic tie down when in a latched configuration.

20. A slow cooker, comprising:
a housing;
a cooking vessel having a rim, said cooking vessel being configured to be removably nestable within said housing;
a lid configured to removably cover said cooking vessel when seated on said rim;
a heating element powered by a power source for heating a food product positioned within an interior of said cooking vessel;
a pair of opposing latches disposed on said lid and complementary engagement members disposed on the sidewall of said housing configured to selectively retain said lid in sealing engagement with said cooking vessel rim and said housing to inhibit leakage of the food stuffs from said interior of said cooking vessel, said latches each including a base attached to said lid and an elastic tie down connected to said base, said elastic tie down having an aperture foamed therein configured to engage the engagement member by extending said elastic tie down such that said aperture is moved into alignment with said engagement member and when said elastic tie down is released said aperture is restrained by said engagement member.

21. The slow cooker of claim 20, wherein said engagement member further includes an attachment base and a projection extending from said attachment base.

22. The slow cooker of claim 20, wherein said elastic tie down further includes a tee handle at an end opposite another end where said elastic tie down is connected to said base.

23. The slow cooker of claim 20, wherein said elastic tie down is formed from an elastomer selected from the group comprised of rubber and silicone.

24. The slow cooker of claim 20, further including a carrying handle extending over said lid from said base of one of said latches to said base of said other of said latches.

25. The slow cooker of claim 24, wherein said carrying handle is arc-shaped.

26. A slow cooker, comprising:
a housing;
a cooking vessel having a rim, said cooking vessel being configured to be removably nestable within said housing;
a lid configured to removably cover said cooking vessel when seated on said rim;
a heating element powered by a power source for heating a food product positioned within an interior of the cooking vessel;
a pair of opposing latches disposed on one of said lid or a sidewall of said housing and complementary engagement members disposed on the other of said lid or sidewall of said housing configured to selectively retain said lid in sealing engagement with said cooking vessel rim and said housing to inhibit leakage of the food stuffs from said interior of said cooking vessel, said latches each including a base attached to said lid or said sidewall of said housing and an elastic tie down connected to said base with an aperture formed therein, said aperture configured to engage said engagement member by extending said elastic tie down such that said aperture is moved in alignment with said engagement member and when said elastic tie down is released said aperture is restrained by said engagement member.

27. The slow cooker of claim 26, wherein said engagement member further includes an attachment base and a projection extending from said attachment base.

28. The slow cooker of claim 26, wherein said elastic tie down further includes a tee handle at an end opposite another end where said tie down is connected to said base.

29. The slow cooker of claim 26, wherein said elastic tie down is formed from an elastomer selected from the group comprised of rubber and silicone.

30. The slow cooker of claim 26, further including a carrying handle extending over said lid from said base of one of said latches to said base of said other of said latches.

31. The slow cooker of claim 30, wherein said carrying handle is arc-shaped.

32. A slow cooker, comprising:
a housing;
a cooking vessel having a rim, said cooking vessel being configured to be removably nestable within said housing;
a lid configured to removably cover said cooking vessel when seated on said rim, wherein said lid further includes a gasket around an outer edge thereof for sealing engagement with said cooking vessel rim;
a heating element powered by a power source for heating a food product positioned within an interior of said cooking vessel;
at least one latch disposed on said lid and an engagement member disposed on a sidewall of said housing configured to selectively retain said lid in sealing engagement with said cooking vessel rim and said housing to inhibit leakage of the food stuffs from said interior of said cooking vessel, said at least one latch including a base attached to said lid and an elastic tie down connected to said base with a stop member formed thereon, said stop member configured to engage said engagement member by extending said elastic tie down such that said stop member is moved past said engagement member and when said elastic tie down is released said stop member is restrained by said engagement member.
